(19) United States
(12) Patent Application Publication
(10) Pub. No.: US 2008/0189176 A1
(43) Pub. Date: Aug. 7, 2008

(54) RENTAL LAND VEHICLE AND FLEET ADVERTISEMENT

(76) Inventor: Peter J. Burns, Phoenix, AZ (US)

Correspondence Address: LEWIS AND ROCA LLP, 40 N. CENTRAL AVENUE, Suite 1900, PHOENIX, AZ, 85004-4429, US

(21) Appl. No.: 11/670,287

(22) Filed: Feb. 1, 2007

(51) Int. Cl. G06Q 30/00

(52) U.S. Cl. 705/14

(57) ABSTRACT

An advertiser pays a fee to have an advertisement placed on a land vehicle to make the vehicle a mobile billboard or a billboard vehicle. An ad containing the advertiser's message can be made of vinyl and wrapped on one or more external surfaces of the vehicle. The vehicle can then be rented or leased by a car company of origin for inclusion in a fleet of such vehicles that are based in one or more identified locations. Location specific chronological traffic patterns and historical and predictive travel for rental and/or leased land vehicles, and driver safety history, are various optional data used in operations research algorithms and analysis to design systems and methods of pricing the rental and/or leasing of land vehicles and their fleets in revenue models to maximize reach and frequency of the advertiser's message with considerations of maximizing profits from advertising, renting, and/or leasing.

### CROSS NOTING

This is application claims priority to U.S. Provisional Application Ser. No. ______, filed Feb. 1, 2006, entitled “AUTOMOBILE-BASED ADVERTISING METHOD,” by Eric Malloff and Peter J. Burns, the entire contents of which is hereby incorporated by reference.

### TECHNICAL FIELD

The present invention relates generally to advertisement, and is more particularly related to apparatus, systems and methods of advertising using surfaces of a rented land vehicle and/or a fleet of land vehicles.

### SUMMARY

In one implementation, there is provided a method of making arrangements with rental car companies whereby identified vehicles are designated as available for advertising graphics and are to be rented to customers at attractive rates.

In another implementation, a method is provided for making arrangements with an advertiser, whereby an advertiser agrees to pay a fee to have an advertisement placed on a designated billboard vehicle.

In yet another implementation, a method is provided for applying to a designated billboard vehicle a full-body vinyl vehicle wrap containing the advertiser's message.

In a still further implementation, a method is provided for including an advertisement wrapped vehicle to a rental car company of origin for inclusion in a fleet of vehicles based in an identified location.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 shows implementations of automobiles each of which is a designated billboard vehicle, where the surface of each vehicle has applied thereto a full-body vinyl vehicle wrap containing an advertiser's message, and where the vehicle is a rental car or a leased car.

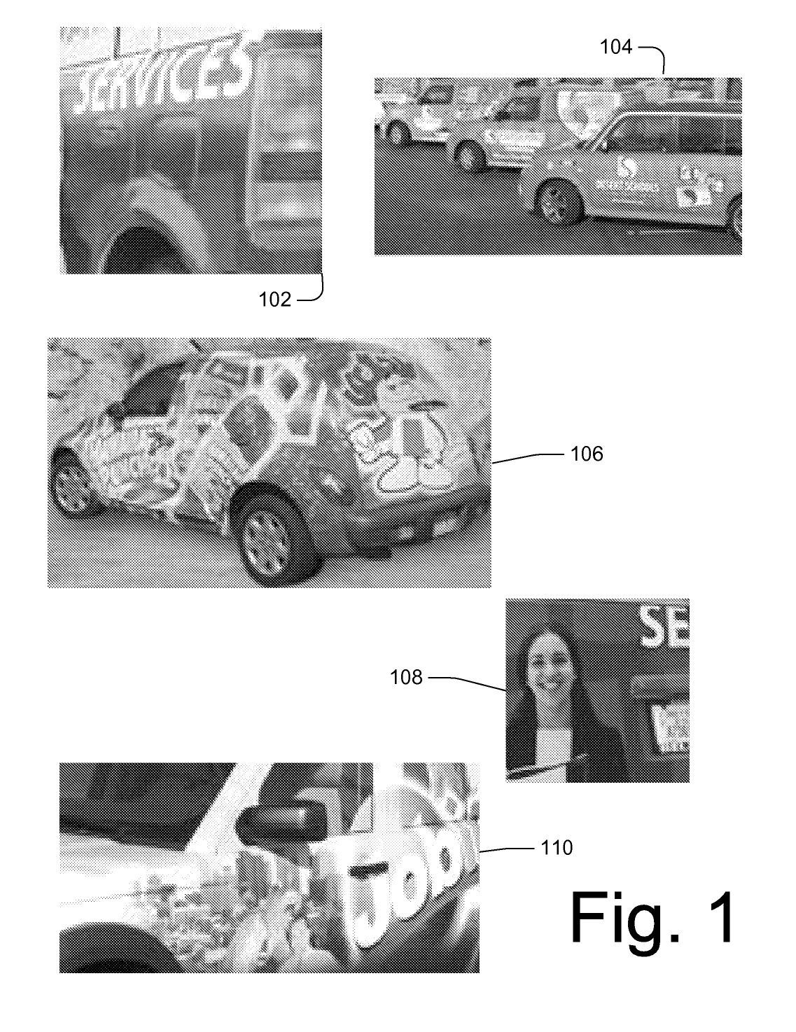

### DESCRIPTION

The present invention will now be described more fully hereinafter with reference to the accompanying drawings, in which some, but not all embodiments of the invention are shown. Indeed, this invention may be embodied in many different forms and should not be construed as limited to the embodiments as set forth herein; rather, these embodiments are provided so that this disclosure will satisfy applicable legal requirements.

The visual impact and uniqueness of automobile mobile billboards provides a cost-effective way to deliver targeted marketing campaigns. Recently-developed technology has made full-body vinyl vehicle wrapping available for any motor vehicle and particularly for any make or model of automobile. This technology, combined with other innovations, forms the basis for the method of providing advertising services described below.

The summary of the business method is quite elegant: The Ad Company, for a fee, (e.g., a daily rate) applies vinyl wrapping with an advertising message to selected vehicles owned by rental car companies under contracts with those companies. The Ad Company “rents” those vehicles at a fleet rate and has the rental car companies offer them “free” (actually, pre-paid by the Ad Company) to customers. Thus, a rental car customer may obtain a vehicle at no charge (or nominal charge) if he is willing to drive a mobile billboard. The Ad Company keeps the differences between the charge to the advertiser and the costs of wrapping and renting the vehicles.

The Mobile Billboard

Full-body vinyl vehicle wraps, digitally configured to exactly fit any make and model of automobile, are available from several companies. These wraps are durable, colorful, and removable without damage to the original paint finish. Computer graphics technology allows one to design a mobile billboard with attention-grabbing visual impact. Because the wrap can be removed and replaced, a single vehicle may be re-used for phases of an advertising campaign or may be changed to a different advertiser after a campaign is finished. Eventually, the vehicle may be sold with its original finish intact.

Rental Car Component

National and local rental car companies maintain large fleets of vehicles. Because of the nature of the product, most rental vehicles are on the road for a high percentage of the rental term. Business renters and vacation renters are likely to be driving to places where their vehicles will be seen by many people.

An advantage of using rental cars as mobile billboards is that the likely dispersion of cars from a home base is generally predictable, affording an opportunity for targeted marketing campaigns.

The rental car aspect of the business method is the establishment of relationships with rental car agencies, either national or local, whereby a portion of the fleet is set aside for billboard wrapping. Billboard cars would then be offered “free” to rental customers. The customer would meet all the criteria for the rental company (e.g., driver's license, major credit card) but would not be charged the vehicle daily rate. Alternatively, a nominal daily rate would be charged. The customer may or may not be charged for insurance, gasoline and the other extras in the standard rental agreement. Because the billboard cars are part of the rental company fleet, all maintenance, inspection, servicing and tracking of the vehicles will be automatically and routinely handled.

The preferred embodiment contemplates that the rental car agency will receive the same revenue it would from customers, except that the Ad Company makes the payment. The availability of “free” billboard cars might also be used to enhance the other aspects of the rental car agency's business.

The Advertiser

The Ad Company contacts with advertising accounts to place graphics and copy on automobile billboards. Packages are possible based on the number of vehicles, particular cities, and the length of the campaign. The rate will be attractive compared to the other forms of outdoor advertising (or any advertising). A virtually unlimited range of eye-catching graphics presentations for the automobile billboards is available.

Additional Features

In addition to the presence of mobile billboards, the Ad Company may alternatively provide tools for market penetration and effectiveness analysis. Integrated Automobile Number Identification (“ANI”) call capture systems may be associated with 1-800 numbers displayed on the vehicle. GPS tracking of display vehicles, in database report format or real-time, is available to determine actual penetration for correlation with measures of effectiveness. Moreover, driving a predetermined time and/or distance on predetermined road systems may result in a predetermined favorable or unfavorable adjustment made to the pricing according to a formula or promotion as provided by a rental/lease agreement and/or advertising agreement, where the time and distance are derived from GPS log data kept for the vehicle's positions and travels.

Operations research (OR) is the application of scientific methods, techniques, and tools to problems involving the operations of a system, to provide those in control of the system with optimum solutions to the problems. OR can be used with various data in implementations to maximize profits from advertising, renting, and/or leasing the above described ad wrapped land vehicles. The design systems and methods using OR will maximize the efficiency of pricing for the rental and/or leasing of land vehicles and their fleets in desirable revenue models. Specifically, modeling can be conducted using OR to most effectively plan who, what and when to rent and and/or lease land vehicles having specific ads. These data for OR modeling may include:
1 location specific chronological traffic patterns;
2. ad size, land vehicle size, and their combinations;
3. density of ads and/or ad type per road system, geographic area, time of day, and calendar period;
4. travel mileage for land vehicles;
5 historical and predictive travel for rental and/or leased land vehicles;
6. driver safety;
7. reach and frequency algorithms for deriving impression, ad message, brand;
8. pricing for ads based upon reach and frequency models;
9. pricing for rental and/or leasing derived, at least in part, from:
   a. a model of deriving reach and frequency;
   b. length, time of day, and/or duration of likely travel;
   c. prior commitments to rent and/lease for specific geographies and/or time frames;
10. combinations of the foregoing.

The above factors can be taken alone, or in various combinations, when pricing land vehicle rentals and/leases, as well as the price for advertising on these vehicles. Computer programs can be used, with the above factors as variable inputs, with actual and prophetic data to derive pricing for renting/leasing land vehicles as well as for the advertising.

present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
offering for rental a fleet of land vehicles at least some of which bear a graphic substantially visible on opposing sides of the land vehicle;
renting the land vehicles to customers at a price differential for those land vehicles bearing the graphic relative to those land vehicles without the graphic.

2. The method as defined in claim 1, wherein each said graphic is an advertising graphic.

3. The method as defined in claim 2, the price differential further comprises a factor selected from the group consisting of:
location specific chronological traffic patterns;
ad size, land vehicle size, and their combinations;
density of ads and/or ad type per road system, geographic area, time of day, and calendar period;
travel mileage for land vehicles;
historical and predictive travel for rental and/or leased land vehicles;
driver safety;
reach and frequency algorithms for deriving impression, ad message, brand;
pricing for ads based upon reach and frequency models;
pricing for rental and/or leasing derived, at least in part, from a model of deriving reach and frequency;
pricing for rental and/or leasing derived, at least in part, from a model of deriving reach and frequency;
pricing for rental and/or leasing derived, at least in part, from length, time of day, and/or duration of likely travel;
pricing for rental and/or leasing derived, at least in part, from prior commitments to rent and/lease for specific geographies and/or time frames; and
combinations of the foregoing.

4. The method as defined in claim 2, wherein the price differential is derived, at least in part, from the driving of the rental vehicle a predetermined time and/or distance on predetermined road systems for a predetermined adjustment according to a condition as provided by a rental/lease agreement for the land vehicle.

5. A computer readable medium comprising computer instructions which, when executed, uses data to derive the price differential as in claim 2.

6. A method comprising making an offer to an agent of an advertiser to put the advertiser's advertising graphics on a fleet of rental land vehicles the rental/lease of which shall be at a price differential for those land vehicles bearing the advertiser's advertising graphics relative to those land vehicles without graphics, wherein the offer for such advertising on the fleet of rental land vehicles is derived at least in part using a factor selected from the group consisting of:
location specific chronological traffic patterns;
ad size, land vehicle size, and their combinations;
density of ads and/or ad type per road system, geographic area, time of day, and calendar period;
travel mileage for land vehicles;
historical and predictive travel for rental and/or leased land vehicles;
driver safety;
reach and frequency algorithms for deriving impression, ad message, brand;
pricing for ads based upon reach and frequency models;
pricing for rental and/or leasing derived, at least in part, from a model of deriving reach and frequency;
pricing for rental and/or leasing derived, at least in part, from a model of deriving reach and frequency;
pricing for rental and/or leasing derived, at least in part, from length, time of day, and/or duration of likely travel;
pricing for rental and/or leasing derived, at least in part, from prior commitments to rent and/lease for specific geographies and/or time frames; and
combinations of the foregoing.

7. A computer readable medium comprising computer instructions which, when executed, uses data to derive the offer as in claim 6.

8. The method as defined in claim 6, wherein the price differential is derived, at least in part, from the driving of the land vehicles a predetermined time and/or distance on predetermined road systems for a predetermined adjustment according to a condition as provided by an advertising agreement.
